(19) United States
(12) Patent Application Publication
(10) Pub. No.: US 2014/0205180 A1
(43) Pub. Date: Jul. 24, 2014

(54) METHOD, APPARATUS AND DEVICE FOR INSPECTING CIRCUIT PATTERN DEFECT

(71) Applicant: Tian-Xing HUANG, Tainan City (TW)

(72) Inventor: Lien-Sheng CHUNG, Jhubei City (TW)

(21) Appl. No.: 14/161,351

(22) Filed: Jan. 22, 2014

(30) Foreign Application Priority Data
Jan. 23, 2013 (TW) 102102459
Sep. 2, 2013 (TW) 102131527

(51) Int. Cl. G06T 7/00

(52) U.S. Cl. CPC G06T 7/0004
USPC 382/149

(57) ABSTRACT

A method for inspecting a defect of a circuit pattern includes obtaining an image containing the circuit pattern, expanding or contracting the circuit pattern contained in the image in one direction, so that a defective first portion of the circuit pattern contained in the image is overlapped after expanding the circuit pattern contained in the image, and so that a second portion formed between defective segments of the circuit pattern contained in the image is eliminated after contracting the circuit pattern contained in the image, and generating an inspection data that is associated with a position of a defect of the circuit pattern based on a position of the first portion or a position of the second portion.

### CROSS-REFERENCE TO RELATED APPLICATIONS

This application claims priority of Taiwanese Application No. 102102459, filed on Jan. 23, 2013, and Application No. 102131527, filed on Sep. 2, 2013.

### BACKGROUND OF THE INVENTION

1. Field of the Invention

The present invention relates to a method, an apparatus and a device for inspecting circuit pattern defects.

2. Description of the Related Art

In the process of semiconductor device fabrication, a photomask provided with a predefined pattern is generally utilized to serve as a mask, so as to form on a substrate a circuit pattern that corresponds to the predefined pattern provided on the photomask. After formation of the circuit pattern, defect inspection with respect to the circuit pattern is usually required in order to determine whether the circuit pattern thus formed contains any defect. The inspected defect is analyzed and categorized, for example, determining whether the inspected defect belongs to an inherent defect in the photomask or a defect resulting from wafer fabrication, such that a result obtained from analyzing and categorizing the inspected defect may serve as a basis for adjusting parameters during fabrication, so as to further improve the fabrication yield.

With respect to defect inspection methods commonly utilized in semiconductor device fabrication, currently, there are two kinds of defect inspection methods, i.e., the die-to-die inspection mode and the die-to-database inspection mode. For example, a die-to-die defect inspection method is disclosed in Taiwanese Patent No. I292601. However, this die-to-die defect inspection method may not detect defects that appear at an identical position of each of dies. Furthermore, referring to a die-to-database inspection apparatus available from KLA-Tencor Corporation, a sample of a corresponding pattern is required to serve as an inspection basis in the die-to-database inspection mode. A relatively high cost is incurred to collect samples of patterns for establishing a sufficient database, and time required for inspection is also increased. In view of the drawbacks of the two inspection modes, a better solution is needed for inspecting circuit pattern defects.

### SUMMARY OF THE INVENTION

Therefore, in a first aspect of the present invention, a method for inspecting a defect of a circuit pattern of a semiconductor device is provided.

Accordingly, the method of the present invention is to be implemented by an inspecting apparatus and comprises the steps of:

(i) obtaining, using the inspection apparatus, an image containing the circuit pattern;

(ii) expanding or contracting, using the inspection apparatus, the circuit pattern contained in the image which is obtained in step (i) in one direction, so that a defective first portion of the circuit pattern contained in the image is overlapped after expanding the circuit pattern contained in the image, and so that a second portion formed between defective segments of the circuit pattern contained in the image is eliminated after contracting the circuit pattern contained in the image; and

(iii) generating, using the inspection apparatus, an inspection data that is associated with a position of a defect of the circuit pattern based on a position of the first portion or a position of the second portion.

In a second aspect of the present invention, a method for inspecting a defect of a circuit pattern of a semiconductor device is provided.

Accordingly, the method is to be implemented by an inspecting apparatus and comprises the steps of:

(K) extracting, using the inspection apparatus, a pattern contour of the circuit pattern from an image containing the circuit pattern;

(L) adjusting, using the inspection apparatus, the pattern contour extracted in step (K) by contracting a dimension of the pattern contour in a first direction, so as to generate a contracted contour;

(M) restoring, using the inspection apparatus, a dimension of the contracted contour in proportion to and in a direction opposite to the first direction in which the dimension of the pattern contour is contracted in step (L), so as to generate a first restored contour;

(N) adjusting, using the inspection apparatus, the pattern contour extracted in step (K) by expanding the dimension of the pattern contour in the first direction, so as to generate an expanded contour;

(O) restoring, using the inspection apparatus, a dimension of the expanded contour in proportion to and in a direction opposite to the first direction in which the dimension of the pattern contour is expanded in step (N), so as to generate a second restored contour; and

(P) performing, using the inspection apparatus, an exclusive or (XOR) logical operation upon the first restored contour and the second restored contour, so as to generate based on a result of the XOR logical operation an inspection data that is associated with a position of a defect of the circuit pattern.

In a third aspect of the present invention, a method for inspecting a defect of a circuit pattern of a semiconductor device is provided.

Accordingly, the method is to be implemented by an inspecting apparatus and comprises the steps of:

(Q) obtaining, using the inspection apparatus, an image containing the circuit pattern that has at least two sides spaced apart from each other along one direction;

(R) measuring, using the inspection apparatus and along the direction, a distance defined by the at least two sides of the circuit pattern contained in the image which is obtained in step (Q); and

(S) comparing, using the inspection apparatus, the distance measured in step (R) with a predetermined fabrication threshold, so as to generate an inspection data that is associated with a position of a defect of the circuit pattern.

### BRIEF DESCRIPTION OF THE DRAWINGS

Other features and advantages of the present invention will become apparent in the following detailed description of the two preferred embodiments with reference to the accompanying drawings, of which:

FIG. 1 is illustrates a first preferred embodiment of an inspection apparatus according to the present invention;

FIG. 2 is a block diagram illustrating a defect inspection device of the first preferred embodiment;

FIG. 3 is a schematic diagram illustrating an image containing a circuit pattern and to be inspected by the first preferred embodiment;

FIG. 4 is a flow chart illustrating a method for inspecting a defect of a circuit pattern according to the present invention;

FIG. 5 is a schematic diagram illustrating a step of extracting a pattern contour of the circuit pattern in the first preferred embodiment;

FIG. 6 illustrates steps of contracting the pattern contour so as to generate a first contour and expanding the first contour so as to generate a second contour;

FIG. 7 illustrates steps of expanding the pattern contour so as to generate the first contour and contracting the first contour so as to generate the second contour;

FIG. 8 is a schematic diagram illustrating a first restored contour and a second restored contour generated by adjusting and restoring a dimension of the pattern contour;

FIG. 9 illustrates a step of dividing the pattern contour into a plurality of sub-pattern contours;

FIG. 10 is a flow chart illustrating a configuration of the first preferred embodiment of the method for inspecting a defect of a circuit pattern;

FIG. 11 illustrates steps of contracting the pattern contour so as to generate a third contour and expanding the third contour so as to generate a fourth contour;

FIG. 12 is a flow chart illustrating another configuration of the first preferred embodiment of the method for inspecting a defect of a circuit pattern;

FIG. 13 illustrates a first contour, a second contour, a fifth contour and a sixth contour generated according to the first preferred embodiment;

FIG. 14 illustrates a second preferred embodiment of the method for inspecting a defect of a circuit pattern according to the present invention, in which the circuit pattern is contracted or expanded along a transverse direction;

FIG. 15 illustrates that the circuit pattern shown in FIG. 14 is contracted or expanded along a longitudinal direction;

FIG. 16 illustrates a configuration of the second preferred embodiment; and

FIG. 17 illustrates a third preferred embodiment of the method for inspecting a defect of a circuit pattern according to the present invention.

### DETAILED DESCRIPTION OF THE PREFERRED EMBODIMENTS

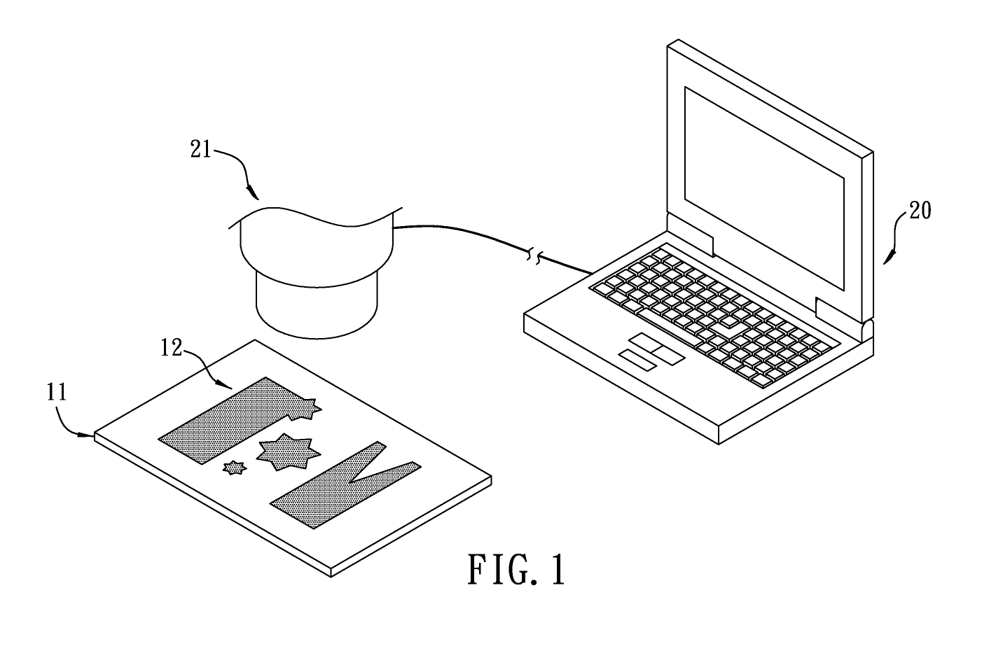

Referring to FIGS. 1, 2, 3 and 5, a first preferred embodiment of a method for inspecting a defect of a circuit pattern according to the present invention is illustrated. The method is to be implemented by an inspection apparatus for inspecting a circuit pattern 12 formed on a substrate 11. The substrate 11 is selected from a wafer, a photomask and a panel. The circuit pattern 12 is a pattern of circuit layout.

The inspection apparatus includes an imaging device 21 and a defect inspection device 20.

The imaging device 21 is selected from a scanning electron microscope and an optical microscope, and is used to capture an image 3 containing the circuit pattern 12 that is formed on the substrate 11. The imaging device 21 is configured to extract a pattern contour 30 of the circuit pattern 12 from the image 3 containing the circuit pattern 12, and is further configured to transmit the pattern contour 30 and the image 3 containing the circuit pattern 12 to the defect inspection device 20.

The defect inspection device 20 is preferably a computer coupled to the imaging device 21, and includes an image database 23 and an analyzing unit 22. The image database 23 stores a plurality of sets of the image 3 containing the circuit pattern 12, and the pattern contour 30 of the circuit pattern 12 that is extracted from the image 3 containing the circuit pattern 12. The analyzing unit 22 includes an image processing module 221 and a defect analyzing module 222. The analyzing unit 22 is configured to receive from the image database 23 the pattern contour 30 and the image 3 containing the circuit pattern 12, and is configured to perform defect analysis. The image processing module 221 is configured to adjust the pattern contour 30 so as to generate a plurality of adjusted contours based on different ways of adjustment. For convenience, the plurality of adjusted contours are designated in sequence as a first contour, a second contour, . . . and a sixth contour. The defect analyzing module 222 is configured to perform defect analysis upon the adjusted contour generated by the image processing module 221, to generate an inspection data based on a result of the defect analysis performed thereby, and to analyze the inspection data so as to generate defect category data that include a random defect group and a consistent defect group.

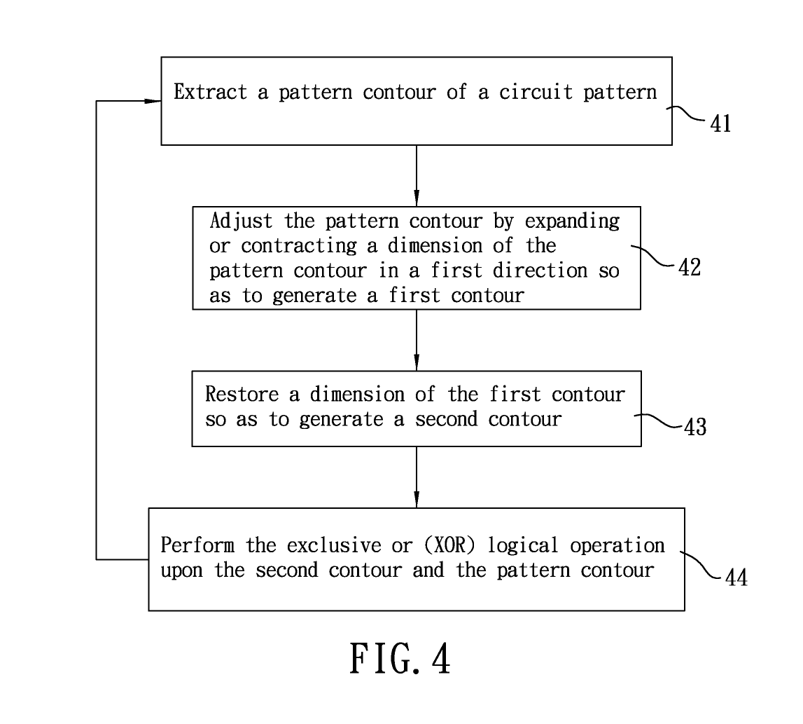

Further referring to FIG. 4, the first preferred embodiment of the method for inspecting a defect of a circuit pattern comprises the following steps.

In step 41, the imaging device 21 is configured to extract the pattern contour 30 of the circuit pattern 12 from the image 3 containing the circuit pattern 12.

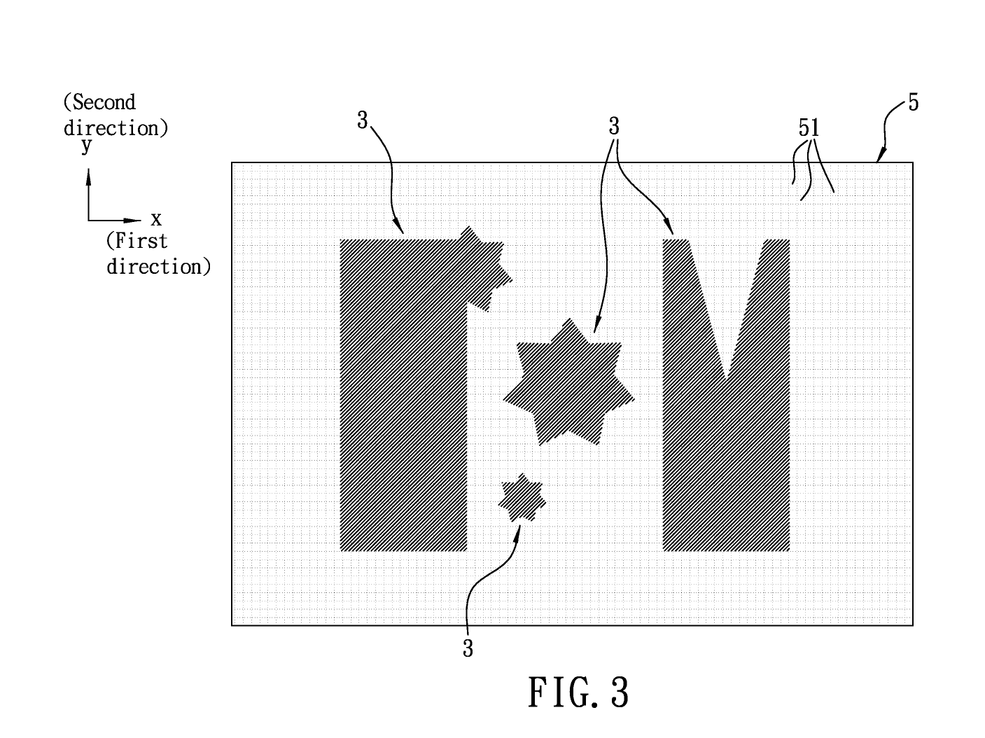

Specifically, in step 41, the imaging device 21 captures the image 3 containing the circuit pattern 12 that is formed on the substrate 11, and renders the image 3 containing the circuit pattern 12 on a two-dimensional plane 5 defined by an X-axis and a Y-axis perpendicular to each other. The two-dimensional plane 5 includes a plurality of pixels 51 that are arranged in a regular two-dimensional grid. The image 3 containing the circuit pattern 12 is represented by parts of the pixels 51 covered by oblique lines as best shown in FIG. 3. Subsequently, the imaging device 21 extracts the pattern contour 30 of the circuit pattern 12 by subjecting the image 3 containing the circuit pattern 12 to processing that is selected from contrast, contrast stretching, gray level processing, and combinations thereof.

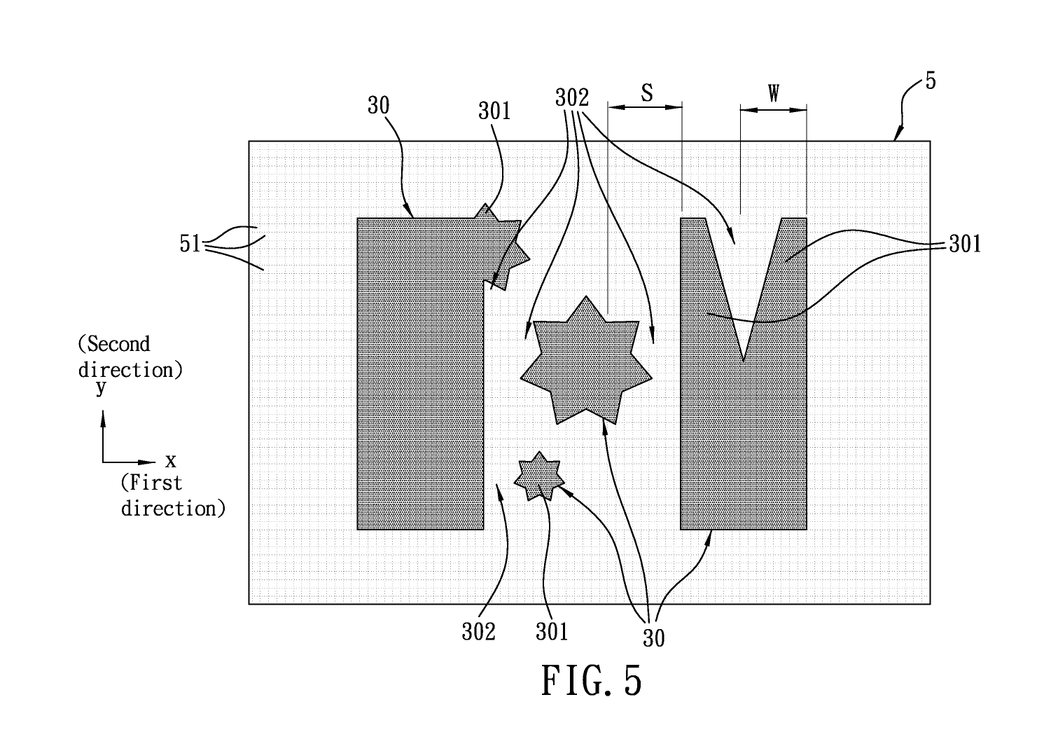

Referring to FIG. 5, an area surrounded by the pattern contour 30 is represented by parts of the pixels of the two-dimensional plane 5 covered with dots. The pattern contour 30 of the circuit pattern 12 includes at least one first elimination portion 301 which has a width along the X-axis smaller than a predetermined width W. Moreover, parts of the pattern contour 30 of the circuit pattern 12 cooperate to define at least one first merging portion 302 therebetween which has a width along the X-axis smaller than a predetermined gap width S. With respect to a circuit pattern on a wafer, there are limitations on minimum widths or minimum gaps for different generations of wafer fabrication. If a pattern has a width smaller than the minimum width limitation, the pattern is determined as abnormal. For example, in the 20-nanometer generation of fabrication, a minimum width for each line is 20 nanometers. If a pitch is set to 80 nanometers, a minimum gap width between two lines should be 60 nanometers. Taking 10% fabrication variation and 10% image error variation into consideration, the predetermined width W is thus set to be about 16 nanometers (i.e., 20 nanometers×80%), and the predetermined gap width S is thus set to be about 48 nanometers (i.e., 60 nanometers×80%).

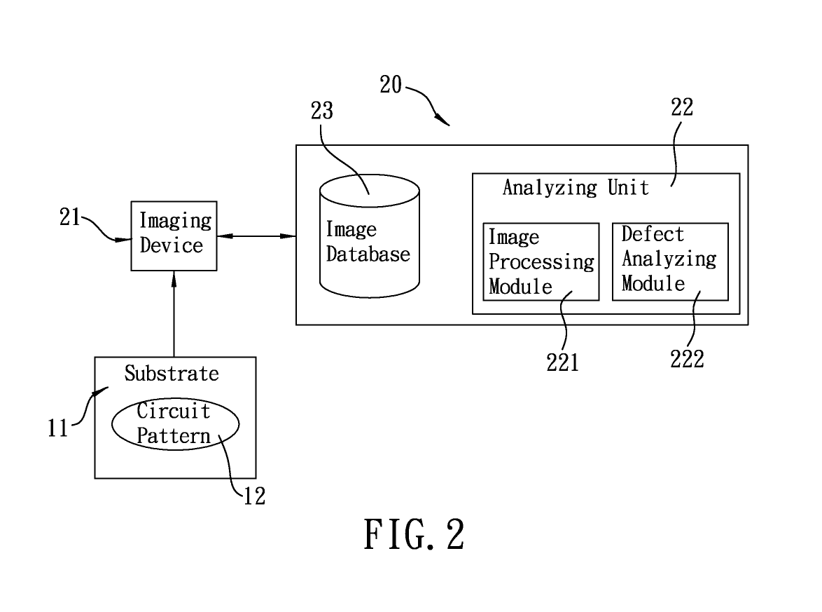

Subsequently, referring to FIGS. 2, 4 and 6, in step 42, the image processing module 221 is configured to adjust the pattern contour 30 extracted in step 41 by expanding or contracting a dimension of the pattern contour 30 in a first direction, so as to generate a first contour 31. In this embodiment, in step 42, the dimension of the pattern contour 30 is contracted in the first direction so as to generate the contracted first contour 31.

Specifically, the first direction is defined to be along the X-axis. In step 42, the image processing module 221 of the analyzing unit 22 contracts each transverse side of the pattern contour 30 inwardly by W/2 in the first direction (i.e., a contracting process), so as to generate the first contour 31. Since the width of the first elimination portion 301 along the X-axis is smaller than the predetermined width W, the first elimination portion 301 is eliminated when the dimension of the pattern contour 30 is contracted in the first direction in step 42. Furthermore, in the case of areas surrounded by segments of the pattern contour 30 whose widths along the X-axis are all smaller than the predetermined width W, said areas are eliminated after the contracting process in step 42.

In step 43, the image processing module 221 is configured to restore a dimension of the first contour 31 in proportion to and in a direction opposite to the first direction in which the dimension of the pattern contour 30 is expanded or contracted in step 42, so as to generate a second contour 32.

Taking the contracting process in step 42 for example, in step 43, the image processing module 221 expands each transverse side of the first contour 31 outwardly by W/2 (i.e., an expanding process) in the direction opposite to the first direction in which the dimension of the pattern contour 30 is contracted in step 42, so as to generate the second contour 32. Since some areas have been eliminated in the previous step 42 (i.e., the first elimination portion 301), the eliminated areas still remain eliminated after the expanding process of step 43.

In step 44, the defect analyzing unit 222 is configured to perform an exclusive or (XOR) logical operation upon the second contour 32 and the pattern contour 30, so as to generate based on a result of the XOR logical operation a first inspection data that is associated with a position of a defect of the circuit pattern 12.

In other words, the defect analyzing unit 222 compares differences and similarities between the second contour 32 and the pattern contour 30, and obtains the first inspection data. In this embodiment, since the pattern contour 30 differs from the second contour 32 in the position of the first elimination portion 301, the first inspection data contains information associated with positions of the pixels 51 which correspond to the first elimination portion 301. The pixels 51 which correspond to the first elimination portion 301 may represent the position of defect. It is noted that the first direction is not limited to be defined to be along the X-axis, and may otherwise be defined to be along the Y-axis or another angle of direction.

Referring to FIGS. 2, 4 and 7, it is noted that in another example, when the image processing module 221 adjusts the pattern contour 30 by expanding each transverse side of the pattern contour 30 outwardly by S/2 in the first direction so as to generate the first contour 31 in step 42, since the width of the first merging portion 302 along the X-axis is smaller than the predetermined gap width S, the first merging portion 302 is overlapped by said parts of the pattern contour 30, which cooperate to define the first merging portion 302 therebetween. Subsequently, in step 43, the image processing module 221 contracts each transverse side of the first contour 31 inwardly by S/2 in the direction opposite to the first direction in which the dimension of the pattern contour 30 is expanded in step 42, so as to generate the second contour 32. Since the first merging portion 302 has been overlapped in the expanding process of step 42, the first merging portion 302 is retained in the contracting process of step 43. In this way, the pattern contour 30 differs from the second contour 32 in the position of the first merging portion 302, such that, in step 44, the first inspection data contains information associated with positions of the pixels 51 which correspond to the first merging portion 302.

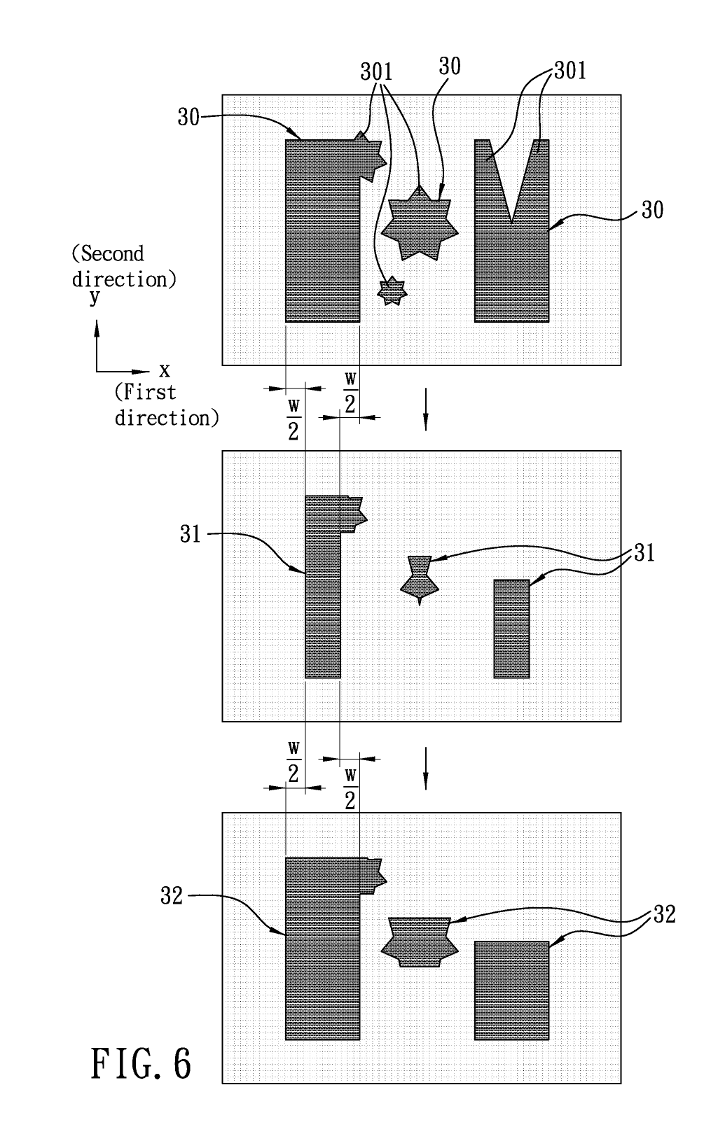

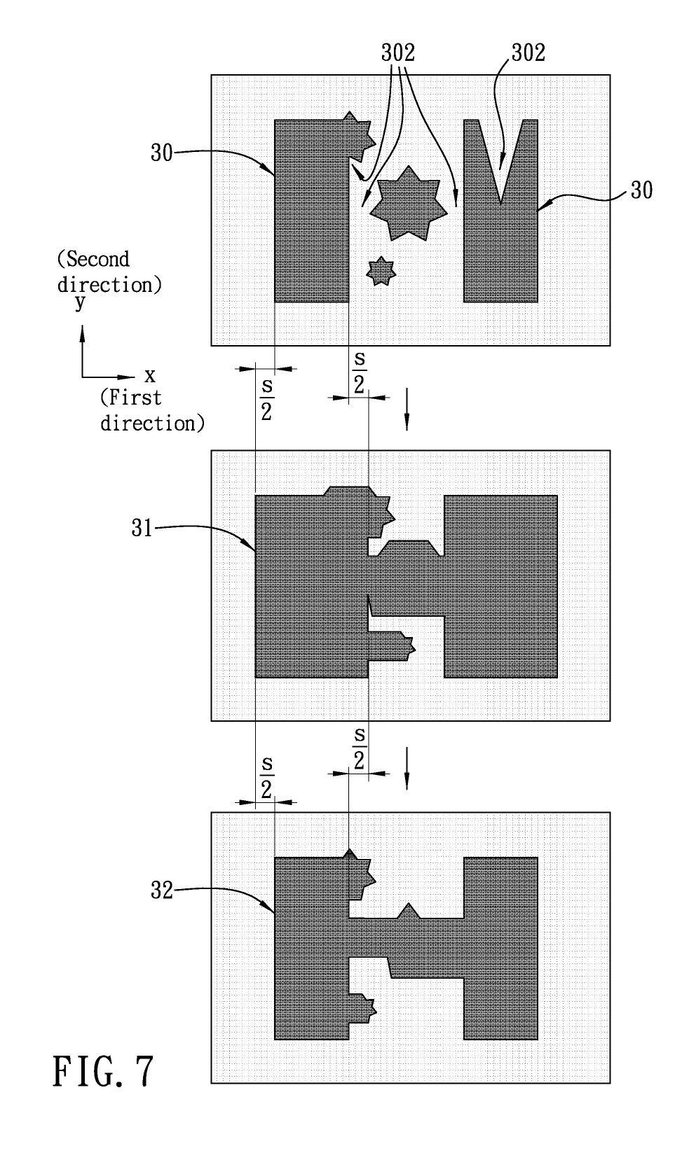

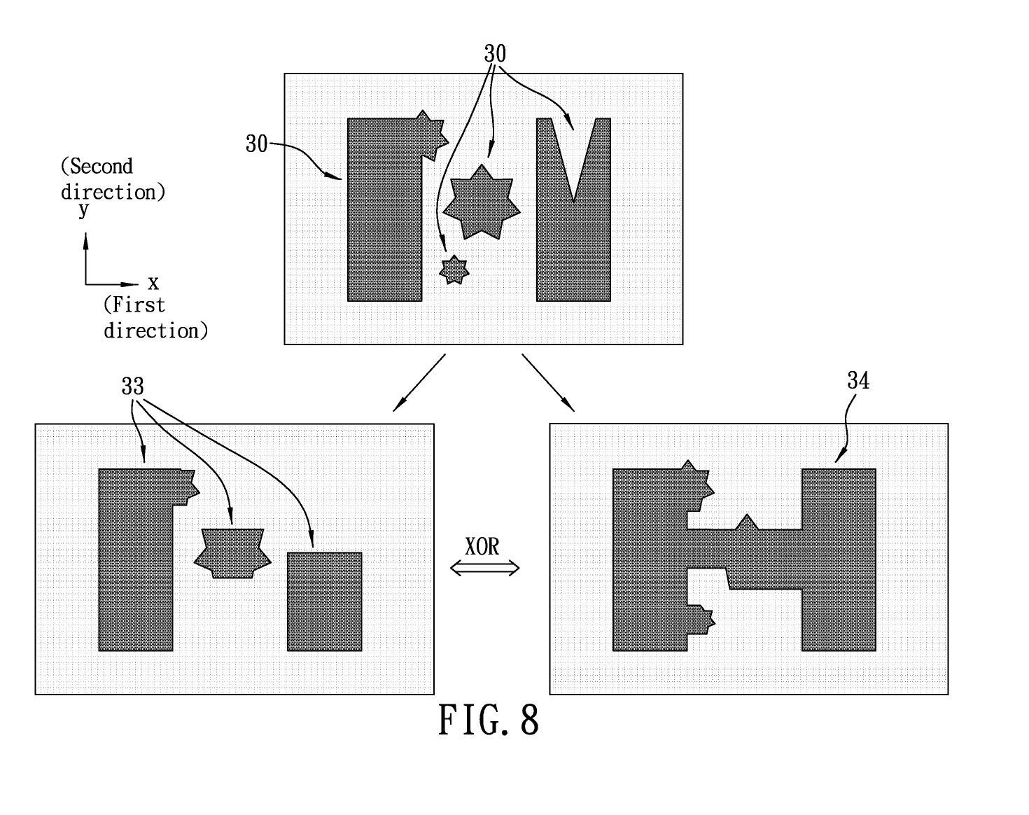

Referring to FIG. 8, the image processing module 221 may be configured to adjust the pattern contour 30 by contracting the dimension of the pattern contour 30 in the first direction so as to generate a contracted contour, and to restore the contracted contour by expanding a dimension thereof so as to generate a first restored contour 33. The image processing module 221 may be further configured to adjust the pattern contour 30 by expanding the dimension of the pattern contour 30 in the first direction so as to generate an expanded contour, and to restore the expanded contour by contracting a dimension thereof so as to generate a second restored contour 34. Subsequently, the defect analyzing module 222 performs the XOR logical operation upon the first restored contour 33 and the second restored contour 34, so as to generate based on a result of the XOR logical operation an inspection data that is associated with a position of a defect of the circuit pattern 12. It is noted that if the XOR logical operation is performed upon the first restored contour 33 and the pattern contour 30, an effect thereof is equivalent to the operation performed in step 44 where the XOR logical operation is performed upon the second pattern 32 shown in FIG. 6 and the pattern contour 30. Similarly, if the XOR logical operation is performed upon the second restored contour 34 and the pattern contour 30, an effect thereof is equivalent to the operation performed in step 44 where the XOR logical operation is performed upon the second pattern 32 shown in FIG. 7 and the pattern contour 30.

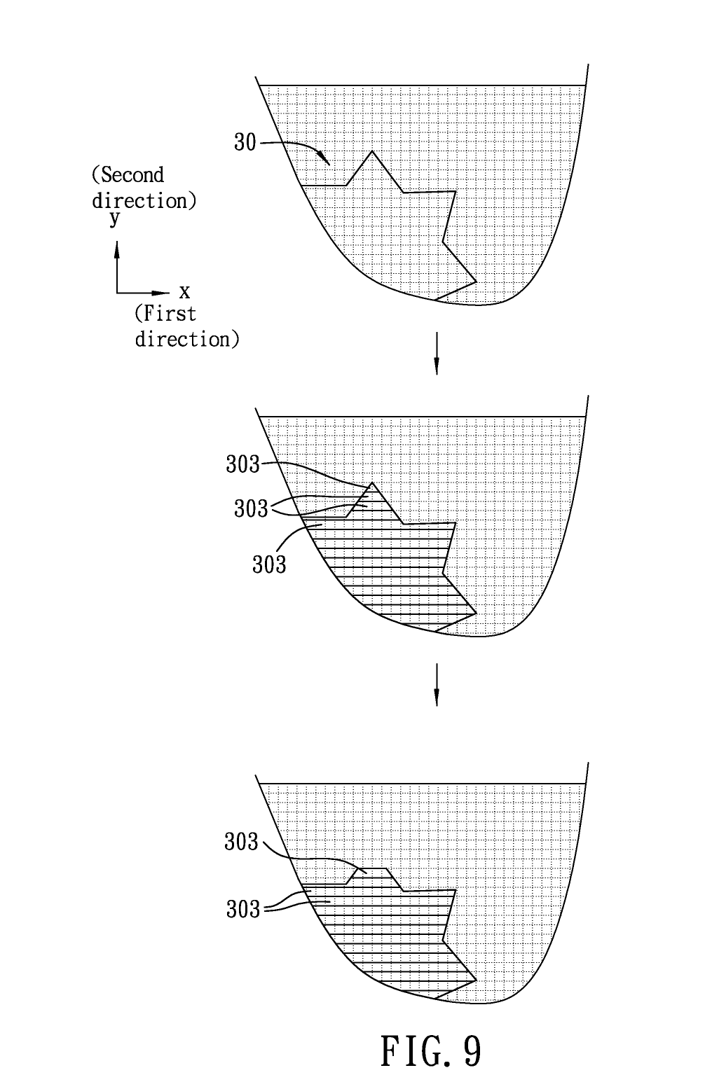

Moreover, referring to FIG. 9, in step 42, the image processing module 221 may be further configured to divide the pattern contour 30 extracted in step 41 into a plurality of sub-pattern contours 303 along the first direction. The reason for this resides in that, during the image processing procedure, the area surrounded by the pattern contour 30 may include many pixels 51, and thus the area surrounded by the pattern contour 30 may be flexibly divided according to different needs. Therefore, the image processing module 221 may subsequently adjust at least one of the sub-pattern contours 300 so as to generate the first contour 31. This technique is beneficial for inspecting defects on a partial area of the circuit pattern 12.

Steps 41 to 44 may be performed on a plurality of the circuit patterns 12 on the substrates 11 for defect inspection so as to generate a plurality of the first inspection data.

Further, after steps 41 to 44 are repeated, the method may further comprise the step of analyzing, using the defect analyzing module 222, the plurality of the first inspection data thus generated so as to generate defect category data. The defect category data includes a random defect group which is associated with positions of the defects of the circuit patterns 12 that have a random distribution, and a consistent defect group which is associated with positions of the defects of the circuit patterns 12 that have a consistent distribution.

For instance, considering the positions of the defects of the circuit patterns 12 that have a random distribution, these defects may be determined to be attributed to the fabrication environment or jig factors, such that the positions of the defects are all different. On the other hand, considering the positions of the defects of the circuit patterns 12 that have a consistent distribution, these defects may be determined to be attributed to inherent factors of the photomask, such as contaminating particles on a photomask or flawed layout in the circuit design stage.

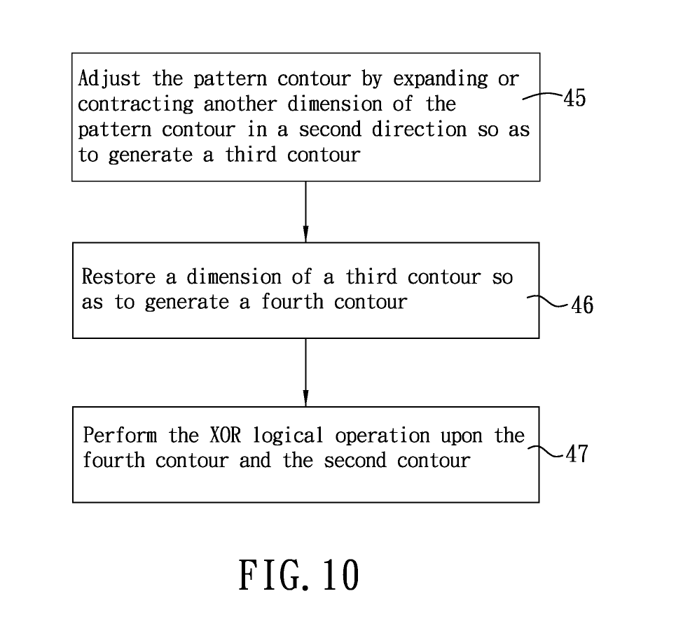

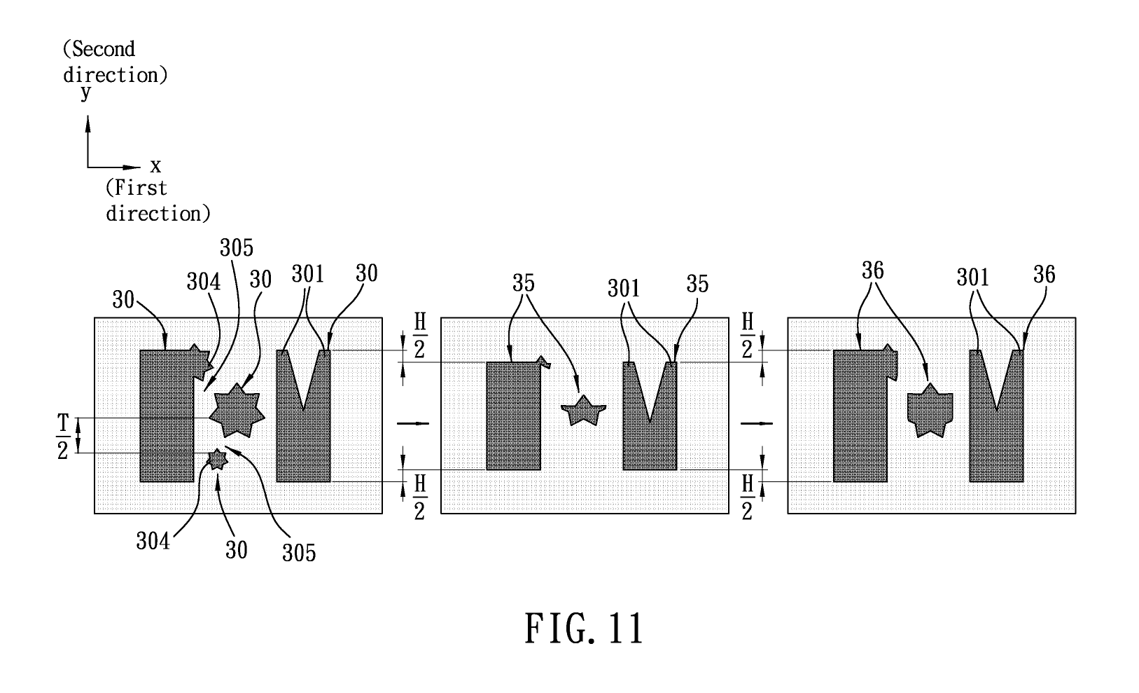

Referring to FIGS. 10 and 11, a configuration of the first preferred embodiment of the method for inspecting a defect of a circuit pattern is illustrated. The configuration of the first preferred embodiment, after steps 41 to 44 are performed, further comprises the following steps.

In step 45, the image processing module 221 is configured to adjust the pattern contour 30 extracted in step 41 by expanding or contracting another dimension of the pattern contour 30 in a second direction different from the first direction, so as to generate a third contour 35. It is noted that the second direction is merely required to be different from the first direction, and is not restricted to form a specific angle with the first direction. In this embodiment, the second direction and the first direction being perpendicular to each other is given as an example for explanation.

Specifically, the second direction is defined to be along the Y-axis which is perpendicular to the X-axis. With respect to the second direction, the pattern contour 30 of the circuit pattern 12 further includes at least one second elimination portion 304 which has a height along the Y-axis smaller than a predetermined height H. Moreover, parts of the pattern contour 30 of the circuit pattern 12 cooperate to define at least one second merging portion 305 therebetween which has a height along the Y-axis smaller than a predetermined gap height T. In the configuration of the first preferred embodiment, in step 45, the dimension of the pattern contour 30 being contracted in the second direction so as to generate the contracted third contour 35 is given as an example for explanation. Specifically, in step 45, the image processing module 221 contracts each longitudinal side of the pattern contour 30 inwardly by H/2 in the second direction (i.e., a contracting process), so as to generate the third contour 35. Since the height of the second elimination portion 304 along the Y-axis is smaller than the predetermined height H, the second elimination portion 304 is eliminated when the dimension of the pattern contour 30 is contracted in the second direction in step 45. It is noted that the first elimination portion 301 having a height along the Y-axis greater than the predetermined height H may not be eliminated as a result of the contracting process along the Y-axis in step 45.

Afterwards, in step 46, the image processing module 221 restores a dimension of the third contour 35 in proportion to and in a direction opposite to the second direction in which the dimension of the pattern contour 30 is contracted in step 45, so as to generate a fourth contour 36.

Taking the contracting process in step 45 for example, in step 46, the image processing module 221 expands each longitudinal side of the third contour 35 outwardly by H/2 (i.e., an expanding process) in the direction opposite to the second direction in which the dimension of the pattern contour 30 is contracted in step 45, so as to generate the fourth contour 36. Since the second elimination portion 304 has been eliminated in the previous step 45, the second elimination portion 304 still remains eliminated after the expanding process of step 46, while the first elimination portion 301 that has the height along the Y-axis greater than the predetermined height H is still retained.

Notably, since a design rule along the first direction may be distinct from that along the second direction, i.e., the predetermined height H is not necessarily equivalent to the aforementioned predetermined width W, a ratio adopted for adjusting the pattern contour 30 in step 42 and for restoring the dimension of the first contour 31 in step 43 may be different from or equal to a ratio adopted for adjusting the pattern contour 30 in step 45 and for restoring the dimension of the third contour 35 in step 46.

Referring to FIGS. 10 and 11 in combination with FIG. 6, in step 47, the defect analyzing module 222 is further configured to perform the XOR logical operation upon the fourth contour 36 and the second contour 32, so as to generate based on a result of the XOR logical operation a second inspection data that is associated with the position of the defect of the circuit pattern 12.

After the pattern contour 30 is adjusted along the second direction in step 45 and the third contour 35 is restored in step 46, the second elimination portion 304 is eliminated while the first elimination portion 301 that has the height along the Y-axis greater than the predetermined height H is still retained in the fourth contour 36. Compared with the second contour 32, the first elimination portion 301 is eliminated after steps 42 and 43. Therefore, in step 47 where the XOR logical operation is performed upon the fourth contour 36 and the second contour 32, the difference between the fourth contour 36 and the second contour 32 which resides in the second elimination portion 304 and the first elimination portion 301 that has the height along the Y-axis greater than the predetermined height H may be determined. In other words, the second inspection data contains information of the positions of the first elimination portion 301 and the second elimination portion 304.

In contrast, if the pattern contour 30 is adjusted by expanding the dimension of the pattern contour 30 in the second direction so as to generate the third contour 35 in step 45, and if the third contour 35 is restored by contracting the dimension thereof so as to generate the fourth contour 36, the second merging portion 305 is overlapped by said parts of the pattern contour 30, which cooperate to define the second merging portion 305 therebetween in step 46. By means of the XOR logical operation performed in step 47, the second merging portion 305 may be determined. Since the aforementioned implementation is similar to the operation as shown in FIG. 7 and is merely different in the direction adopted for adjustment, i.e., along the Y-axis instead of the X-axis, a detailed description in combination with an accompanying drawing is omitted for the sake of brevity.

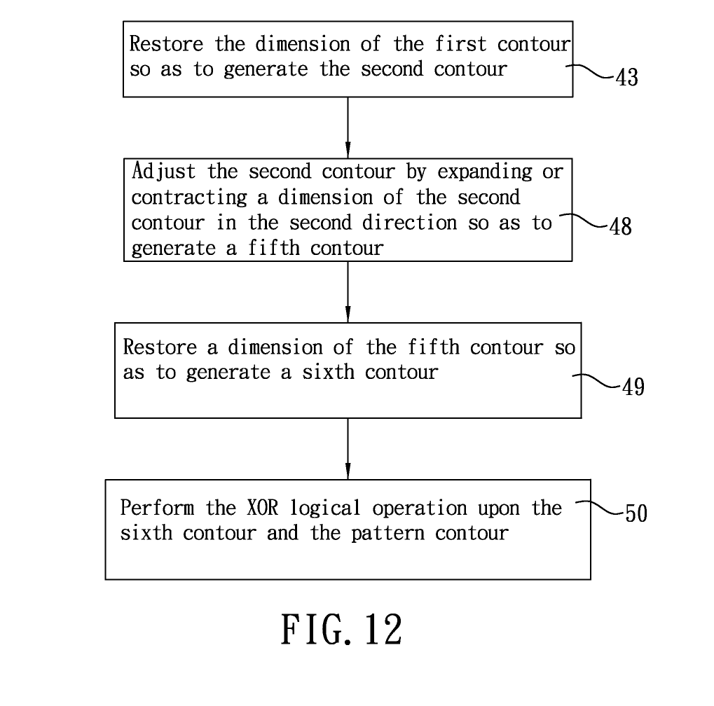

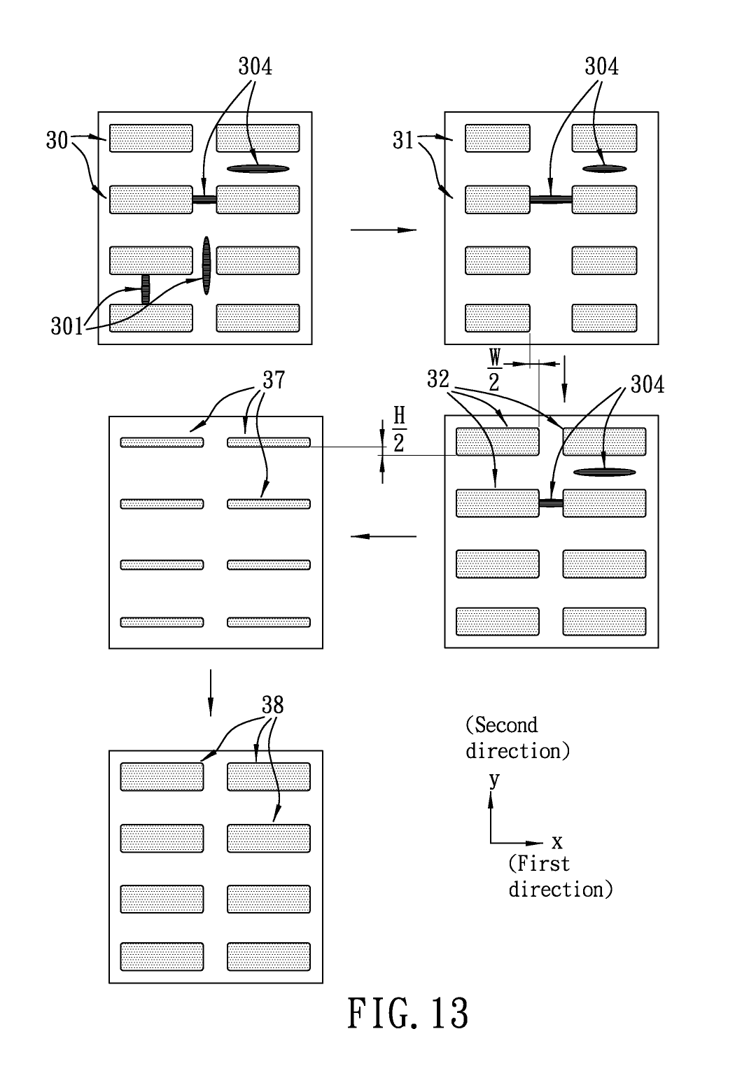

Referring to FIGS. 4, 12 and 13, another configuration of the first preferred embodiment of the method for inspecting a defect of a circuit pattern according to the present invention is performed subsequent to step 43 such that the second contour 32 is further processed by the following steps. For ease of understanding, the pattern contour 30 shown in FIG. 13 is represented by another pattern. The pattern contour 30 of the circuit pattern 12 includes at least one first elimination portion 301 and at least one second elimination portion 304. A contracting process in step 42 and an expanding process in step 43 are given herein as examples for explanation. The pattern contour 30 is first adjusted by contracting the dimension thereof in the first direction so as to generate the first contour 31, and subsequently the first contour 31 is restored by expanding the dimension of the first contour 31 in proportion to and in the direction opposite to the first direction in which the dimension of the pattern contour 30 is contracted so as to generate the second contour 32. In the meantime, the first elimination portion 301 of the pattern contour 30 has been eliminated in the second contour 32.

Subsequent to step 43, in step 48, the image processing module 221 is configured to adjust the second contour 32 generated in step 43 by expanding or contracting a dimension of the second contour 32 in the second direction different from the first direction, so as to generate a fifth contour 37.

Specifically, in step 48, the image processing module 221 contracts each longitudinal side of the second contour 32 inwardly by H/2 in the second direction (i.e., a contracting process), so as to generate the fifth contour 37. The second elimination portion 304 of the pattern contour 30 is eliminated in the fifth contour 37 after the contracting process in step 48.

In step 49, the image processing module 221 restores a dimension of the fifth contour 37 in proportion to and in a direction opposite to the second direction in which the dimension of the second contour 32 is expanded or contracted in step 48, so as to generate a sixth contour 38.

Specifically, the image processing module 221 expands each longitudinal side of the fifth contour 37 outwardly by H/2 (i.e., an expanding process) in the direction opposite to the second direction in which the dimension of the second contour 32 is contracted in step 48, so as to generate the fourth contour 36. Since the second elimination portion 304 has been eliminated in the previous step 48, the second elimination portion 304 still remains eliminated after the expanding process of step 49.

In step 50, the defect analyzing module 222 performs the XOR logical operation upon the sixth contour 38 and the pattern contour 30, so as to generate based on a result of the XOR logical operation a third inspection data that is associated with the position of the defect of the circuit pattern 12.

Since the pattern contour 30 includes the first elimination portion 301 and the second elimination portion 304 which are eliminated in the sixth contour 38, the positions of the first and second elimination portions 301 and 304 may be determined after the XOR logical operation performed in step 50. The third inspection data contains information of the positions of the first and second elimination portions 301 and 304.

In practice, if the pattern contour 30 is expanded outwardly by S/2 in the first direction in step 42, and if the first contour 31 is contracted inwardly by S/2 in the direction opposite to the first direction in step 43, the second contour 32 should be expanded outwardly by T/2 in the second direction in step 48, and the fifth contour 37 should be contracted inwardly by T/2 in the direction opposite to the second direction in step 49, so as to generate the sixth contour 38. In this way, the sixth contour 38 differs from the pattern contour 30 in positions of the first merging portion 302 which has the width along the X-axis smaller than a predetermined gap width S, and of the second merging portion 305 which has the height along the Y-axis smaller than the predetermined gap height T. The differences may be determined by the XOR logical operations. Since the aforementioned processes may be readily appreciated by those skilled in the art with reference to the foregoing description, further details and drawings to illustrate the same are omitted herein for the sake of brevity.

The present invention may be adopted to inspect positions of portions of the pattern contour whose width and height are respectively smaller than predetermined values (such as the predetermined width W and the predetermined height H), or to inspect positions of portions which are defined by parts of the pattern contour therebetween and which have a width and a height respectively smaller than predetermined values (such as the predetermined gap width S and the predetermined gap height T). Therefore, before inspecting a defect of the circuit pattern 12, a minimum width threshold, a minimum height threshold or a minimum gap dimension threshold for a theoretically regular pattern contour of the pattern circuit 12 may be defined. After the aforementioned expanding and contracting processes, a portion of the pattern contour that has a dimension smaller than a minimum width threshold, a minimum height threshold or a minimum gap dimension threshold may be inspected. The portion is one of the aforesaid first elimination portion 301, the second elimination portion 304, the first merging portion 302 and the second merging portion 305.

In a second preferred embodiment of the method for inspecting a defect of a circuit pattern according to the present invention, an image containing any sub-region of a to-be-inspected region of a semiconductor device may be expanded or contracted so as to generate an overlapped region or an eliminated region. By analyzing the overlapped region or the eliminated region, an inspection data of the image containing said sub-region may be directly obtained. A position of the overlapped portion or the eliminated portion after the expanding or contacting process may be determined by means of measuring coordinates of a contour of the sub-region which undergoes the expanding or contracting process.

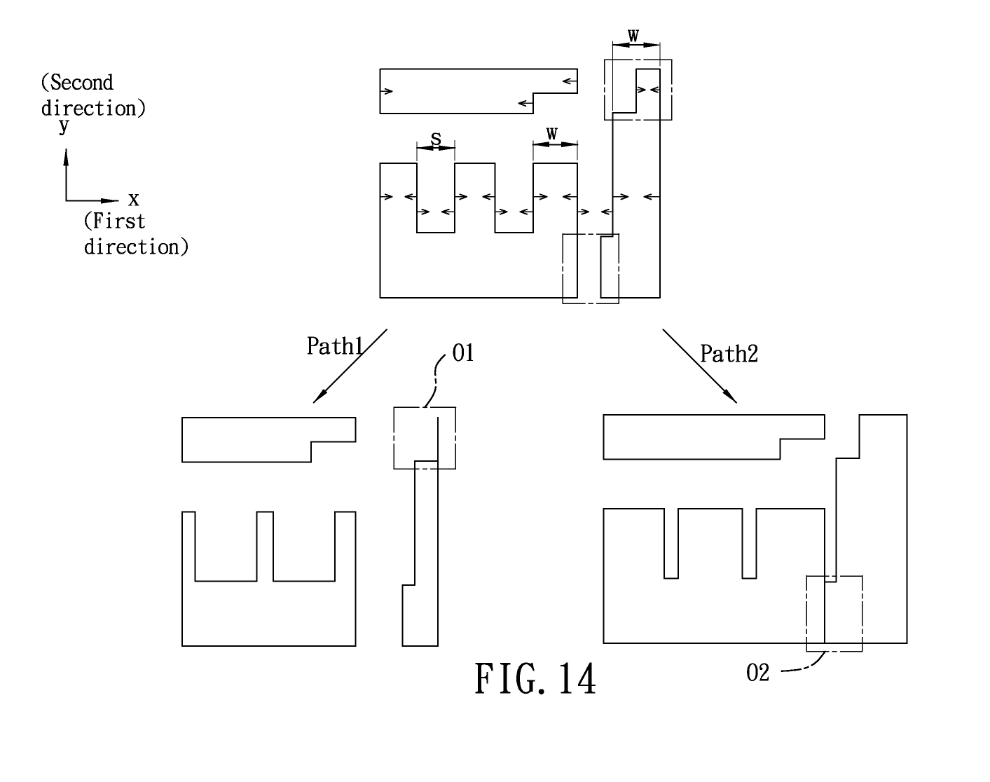

Referring to FIG. 14, a to-be-inspected region of a semiconductor device including three adjacent circuit pattern segments is given as an example for illustrating the second preferred embodiment of the present invention. It is assumed that, in the fabrication process, a predetermined spacing between any adjacent two of circuit pattern segments and a predetermined spacing between lines of an identical circuit pattern segment are both set to be S, and a predetermined line width is set to be W. The imaging device 21 is configured to capture an image containing the three circuit pattern segments. Similar to the first preferred embodiment, when the circuit pattern segments contained in the image are contracted in a first direction x (i.e., a transverse direction) by one-half of the predetermined line width W/2 (see Path1), a first portion of one of the circuit pattern segments (i.e., an elimination region O1) having a width smaller than W/2 will be eliminated after the contracting process. Therefore, an inspection data may be generated by the defect analyzing unit 222 based on a position of the elimination region O1. On the other hand, when the circuit pattern segments contained in the image are expanded in the transverse direction by one-half of the predetermined spacing S/2, a second portion (i.e., an overlapped region O2) which is formed between adjacent two of the circuit pattern segments and which has a width smaller than S/2 will be overlapped after the expanding process. Therefore, another inspection data may be generated by the defect analyzing unit 222 based on a position of the overlapped region O2. In this embodiment, the defect analyzing module 222 is configured to perform contour analysis upon the circuit pattern segments which are contained in the image and which undergo the contracting or expanding process so as to generate the inspection data. Accordingly, the position of the elimination region O1 or the overlapped region O2 after the contracting process or the expanding process performed upon the circuit pattern segments of the to-be-inspected region contained in the image may be directly analyzed, so as to directly obtain the inspection data associated with a position of a defect of the circuit pattern along the transverse direction.

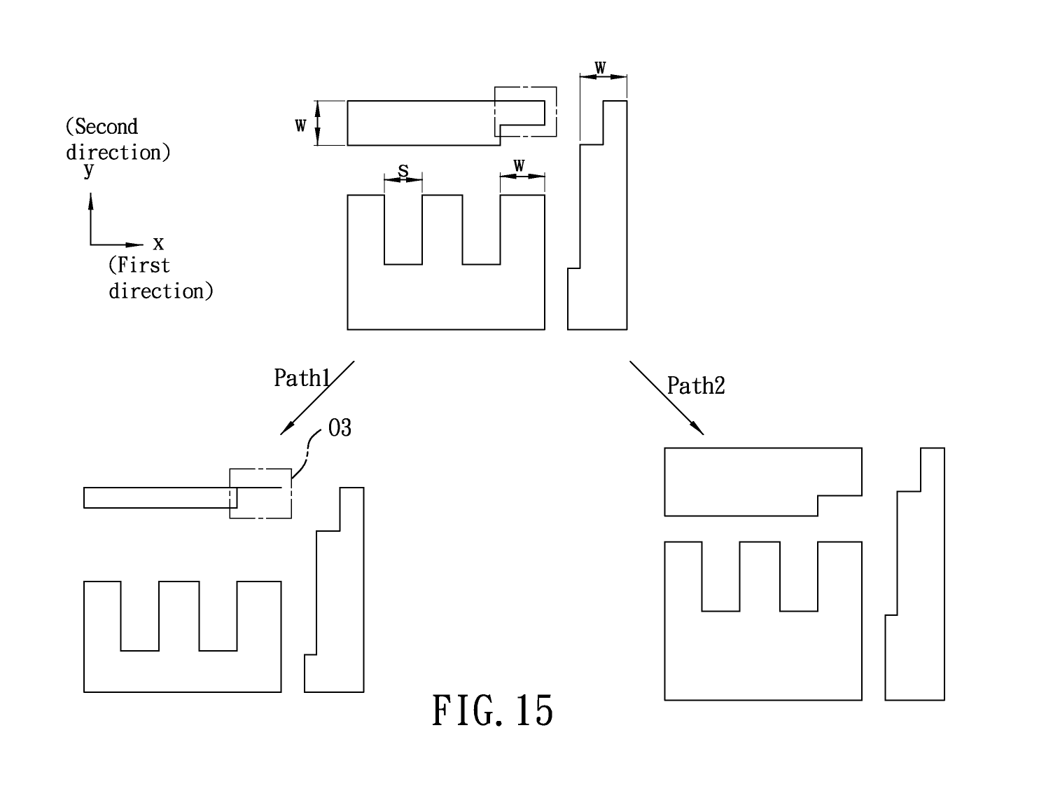

Furthermore, the circuit pattern segments contained in the image captured by the imaging device 21 may be further subjected to the similar contracting process and/or expanding process along a second direction y different from the first direction x, such as a longitudinal direction. In this way, a position of a defect of the circuit pattern segments may be further inspected. Referring to FIG. 15, the circuit pattern segments contained in the image as shown in FIG. 14 are contracted (Path1) and expanded (Path2) in the longitudinal direction, respectively. Accordingly, a position of a defect region O3 of the circuit pattern segments which cannot be inspected during the contracting and/or expanding processes in the transverse direction may be further inspected.

It is noted that, when expanding or contracting the circuit pattern segments contained in the image in a predetermined direction, an integrity of the circuit pattern segments contained in the image is expanded or contracted in the predetermined direction. Alternatively, the circuit pattern segments contained in the image may be divided into a plurality of sub-patterns along the predetermined direction, and one of the sub-patterns may be selected for the subsequent expanding process and/or contracting process. In this way, a local inspection of the circuit pattern segments may be realized.

Moreover, aside from analyzing the circuit pattern segments of the to-be-inspected region on the same focal plane of a microscope of the inspection apparatus, the method for inspecting a defect of a circuit pattern according to the present invention may be used to inspect defects of the to-be-inspected region on different focal planes. For example, when it is desired to inspect defects on a surface circuit and in a trench of a semiconductor device, an image of the surface circuit and an image of the trench may be respectively captured in advance, and the aforementioned method may be subsequently utilized to analyze the images of the circuit pattern and the trench, respectively, so as to directly obtain inspection data associated with defects on the surface circuit and in the trench.

It is noted that when the method for inspecting a defect of a circuit pattern according to the present invention is used to analyze a circuit pattern that is formed by using photomasks for multiple exposures on the same wafer, or to analyze circuit patterns that are formed by using the same photomask on different wafers, each of the circuit patterns formed by a respective exposure may be first subjected to the aforementioned method of the present invention so as to obtain a plurality of inspection data associated with defects of the circuit pattern, and the plurality of inspection data may be analyzed subsequently. In this way, the plurality of the inspection data associated with defects may be categorized into a consistent defect group which is associated with positions of the defects of the photomasks that have a consistent distribution, and into a random defect group which is associated with positions of the defects of the circuit patterns that have a random distribution due to machines or fabrication processes. Therefore, by determining that the defects are caused by one of the fabrication processes, the photomasks and the machines, a feedback adjustment may be performed correspondingly.

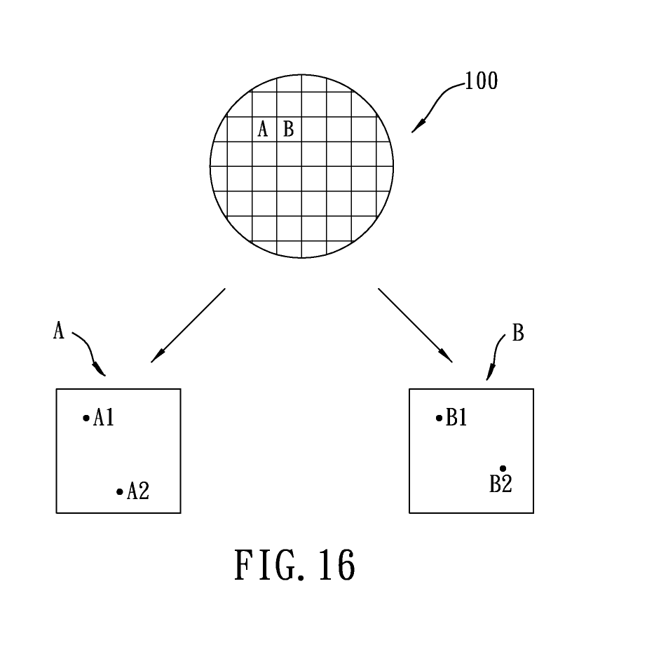

Referring to FIG. 16, two shots A and B on an identical chip 100 by using a photomask for aligned exposures upon a wafer are illustrated. Two entries of inspection data associated with defects are obtained using the method of the present invention. In FIG. 16, A1 and A2 along with B1 and B2 are illustrated for representing positions of defects obtained after analyzing the two shots A and B. Since the positions of defects A1 and B1 relative to a position of the photomask when the photomask is aligned for exposure are substantially identical, the positions of defects A1 and B1 may be categorized into the consistent defect group. In contrast, since the positions of defects A2 and B2 relative to the position of the photomask when the photomask is aligned for exposure are different, the positions of defects A2 and B2 may be categorized into the random defect group. Accordingly, the aforementioned configuration of the second preferred embodiment may be used to determine reasons for appearances of defects (A1, A2 and B1, B2) resulting from different exposure times upon the wafer.

Further, the method for inspecting a defect of a circuit pattern according to the present invention, aside from expanding and/or contracting a circuit pattern so as to inspect defects thereof, may further utilize direct measurement of the circuit pattern and compare a result of the measurement with a predetermined parameter or value so as to inspect a defect of the circuit pattern.

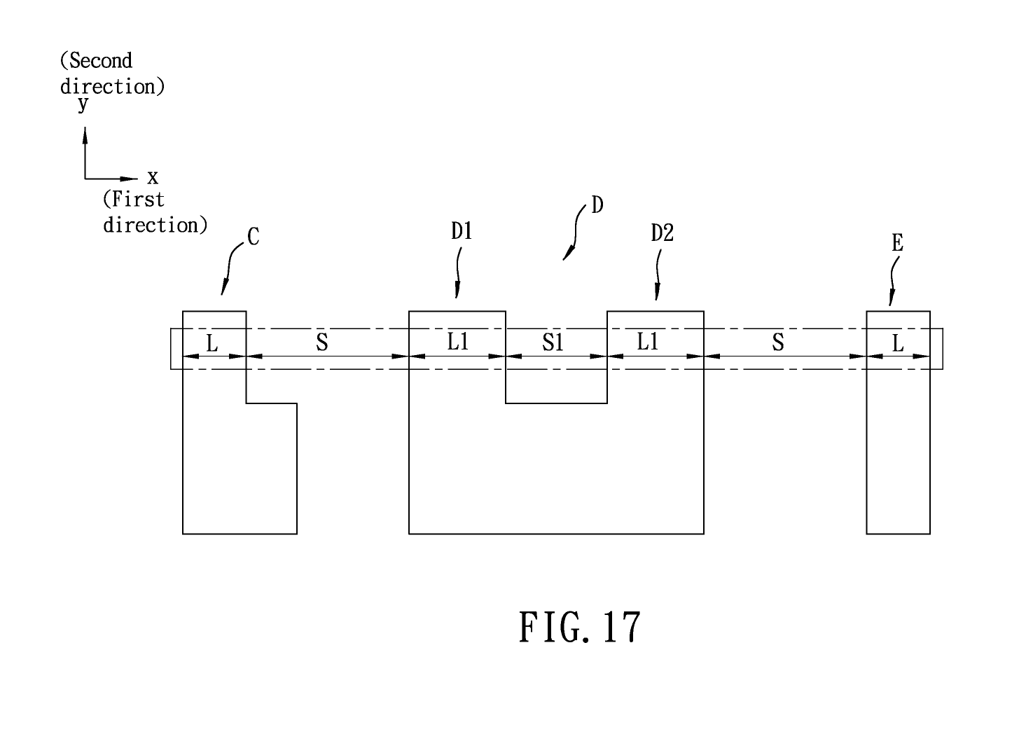

Referring to FIG. 17, three adjacent circuit pattern segments of a to-be-inspected region of a semiconductor device are given as an example for explanation. First, an image containing the three circuit pattern segments C, D, E of the to-be-inspected region of the semiconductor device is captured by the imaging device 21. Each of the circuit pattern segments C, D, E includes at least one first side facing an adjacent one of the circuit pattern segments C, D, E along the first direction x. Each of the circuit pattern segments C, D, E further includes a pair of second sides that define said circuit pattern segment along the first direction x. The circuit pattern segment D further includes two sub-portions D1 and D2 that are spaced apart from each other along the first direction x. Each of the sub-portions D1 and D2 includes at least one third side facing an adjacent one of the sub-portions D1 and D2 along the first direction x. Each of the sub-portions D1 and D2 further includes a pair of fourth sides that define the sub-portion D1, D2 along the first direction x. It is noted that the defect analyzing unit 222 is configured to determine the aforementioned first to fourth sides by detecting side edges of the circuit pattern segments C, D, E along the first direction x. Moreover, the aforementioned first to fourth sides may be determined by subjecting the image containing the circuit pattern to processing that is selected from contrast, contrast stretching, gray level processing, and combinations thereof. Subsequently, the defect analyzing unit 222 is further configured to measure, in a predetermined area (the area surrounded by broken lines) along the first direction x, a first distance S defined by adjacent two of the first sides that face each other, a second distance L defined by the pair of second sides of each of the circuit pattern segments C, D, E, a third distance S1 defined by adjacent two of the third sides that face each other, and a fourth distance L1 defined by the pair of fourth sides of each of the sub-portions D1 and D2. Finally, the defect analyzing unit 222 is further configured to compare the second and fourth distances L and L1 measured thereby with a first predetermined fabrication threshold, respectively, and to compare the first and third distances S and S1 measured thereby with a second predetermined fabrication threshold, respectively, so as to obtain a plurality of entries of inspection data. In this embodiment, the first predetermined fabrication threshold is a minimum allowable line width for circuit pattern segments, and the second predetermined fabrication threshold is a minimum allowable line gap for circuit pattern segments. Therefore, the second and fourth distances L and L1 should both be not smaller than the first predetermined fabrication threshold, and the first and third distances S and S1 should both be not smaller than the second predetermined fabrication threshold. When a result of the comparison does not satisfy the aforementioned conditions, a position of a defect may be determined atone of the first to fourth distances S, L, S1 and L1.

It is noted that the circuit pattern segments C, D, E may also be divided along the first direction x into a plurality of sub-segments, and one of the sub-segments may be selected to be measured along the first direction x so as to obtain the first to fourth distances S, L, S1 and L1 for subsequent comparison analysis. In this way, local inspection may be applied upon the circuit pattern segments for inspecting a defect in a local area of the circuit pattern segments.

To sum up, the method, apparatus and device for inspecting a defect of a circuit pattern according to the present invention provide a novel defect inspection mode which is applicable to semiconductor device fabrication or panel device fabrication. During the procedure of the defect inspection mode, only the image 3 containing the to-be-inspected circuit pattern 12 is required. By virtue of directly measuring a distance between two sides of the circuit pattern, or by virtue of performing image processing and/or logical operation upon the pattern contour 30 of the circuit pattern 12, the position of the defect of the circuit pattern 12 may be inspected without additional cost of pattern samples for inspection. Moreover, the defects of the circuit patterns 12 that have a consistent distribution may also be inspected.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for inspecting a defect of a circuit pattern of a semiconductor device, the method to be implemented by an inspection apparatus and comprising the steps of:
(i) obtaining, using the inspection apparatus, an image containing the circuit pattern;
(ii) expanding or contracting, using the inspection apparatus, the circuit pattern contained in the image which is obtained in step (i) in one direction, so that a defective first portion of the circuit pattern contained in the image is overlapped after expanding the circuit pattern contained in the image, and so that a second portion formed between defective segments of the circuit pattern contained in the image is eliminated after contracting the circuit pattern contained in the image; and
(iii) generating, using the inspection apparatus, an inspection data that is associated with a position of a defect of the circuit pattern based on a position of the first portion or a position of the second portion.

2. The method as claimed in claim 1, the semiconductor device including a surface circuit located at a first surface, and a trench located at a second surface different from the first surface;
wherein, in step (i), the image containing the circuit pattern is captured from one of the surface circuit and the trench of the semiconductor device.

3. The method as claimed in claim 1, wherein steps (i) to (iii) are performed on a plurality of the circuit patterns so as to generate a plurality of the inspection data, the method further comprising:
analyzing, using the inspection apparatus, the plurality of the inspection data thus generated so as to generate defect category data, the defect category data including a random defect group which is associated with positions of the defects of the circuit patterns that have a random distribution, and a consistent defect group which is associated with positions of the defects of the circuit patterns that have a consistent distribution.

4. The method as claimed in claim 1, further comprising:
(A) extracting, using the inspection apparatus, a pattern contour of the circuit pattern from the image containing the circuit pattern;
(B) adjusting, using the inspection apparatus, the pattern contour extracted in step (A) by expanding or contracting a dimension of the pattern contour in a first direction, so as to generate a first contour;
(C) restoring, using the inspection apparatus, a dimension of the first contour in proportion to and in a direction opposite to the first direction in which the dimension of the pattern contour is expanded or contracted in step (B), so as to generate a second contour; and
(D) performing, using the inspection apparatus, an exclusive or (XOR) logical operation upon the second contour and the pattern contour, so as to generate based on a result of the XOR logical operation a first inspection data that is associated with a position of a defect of the circuit pattern.

5. The method as claimed in claim 4, wherein steps (A) to (D) are performed on a plurality of the circuit patterns so as to generate a plurality of the first inspection data, the method further comprising:
analyzing, using the inspection apparatus, the plurality of the first inspection data thus generated so as to generate defect category data, the defect category data including a random defect group which is associated with positions of the defects of the circuit patterns that have a random distribution, and a consistent defect group which is associated with positions of the defects of the circuit patterns that have a consistent distribution.

6. The method as claimed in claim 4, further comprising the steps of:
(E) adjusting, using the inspection apparatus, the pattern contour extracted in step (A) by expanding or contracting another dimension of the pattern contour in a second direction different from the first direction, so as to generate a third contour;
(F) restoring, using the inspection apparatus, a dimension of the third contour in proportion to and in a direction opposite to the second direction in which said another dimension of the pattern contour is expanded or contracted in step (E), so as to generate a fourth contour; and
(G) performing, using the inspection apparatus, the XOR logical operation upon the fourth contour and the second contour, so as to generate based on a result of the XOR logical operation a second inspection data that is associated with the position of the defect of the circuit pattern.
wherein a ratio adopted for adjusting the pattern contour in step (B) and for restoring the dimension of the first contour in step (C) is the same or different from a ratio adopted for adjusting the pattern contour in step (E) and for restoring the dimension of the third contour in step (F)

7. The method as claimed in claim 4, further comprising the steps of:
(H) adjusting, using the inspection apparatus, the second contour generated in step (C) by expanding or contracting a dimension of the second contour in a second direction different from the first direction, so as to generate a fifth contour;
(I) restoring, using the inspection apparatus, a dimension of the fifth contour in proportion to and in a direction opposite to the second direction in which the dimension of the second contour is expanded or contracted in step (H), so as to generate a sixth contour; and
(J) performing, using the inspection apparatus, the XOR logical operation upon the sixth contour and the pattern contour, so as to generate based on a result of the XOR logical operation a third inspection data that is associated with the position of the defect of the circuit pattern;
wherein a ratio adopted for adjusting the pattern contour in step (B) and for restoring the dimension of the first contour in step (C) is the same or different from a ratio adopted for adjusting the second contour in step (H) and for restoring the dimension of the fifth contour in step (I).

8. The method as claimed in claim 1, wherein, in step (i), the image containing the circuit pattern is captured using one of a scanning electron microscope and an optical microscope of the inspection apparatus.

9. The method as claimed in claim 4,
wherein, in step (A), the pattern contour extracted from the image containing the circuit pattern is two-dimensional; and
wherein step (B) includes the sub-steps of
dividing, using the inspection apparatus, the pattern contour extracted in step (A) into a plurality of sub-pattern contours along the first direction, and
adjusting, using the inspection apparatus, at least one of the sub-pattern contours so as to generate the first contour.

10. The method as claimed in claim 4, wherein, in step (A), the pattern contour of the circuit pattern is extracted by subjecting the image containing the circuit pattern to processing that is selected from contrast, contrast stretching, gray level processing, and combinations thereof.

11. The method as claimed in claim 4,
wherein, in step (A), parts of the pattern contour of the circuit pattern cooperate to define a merging portion therebetween which is to be overlapped by said parts of the pattern contour when the dimension of the pattern contour is expanded in the first direction in step (B); and
wherein, in step (A), the pattern contour of the circuit pattern includes an elimination portion which is to be eliminated when the dimension of the pattern contour is contracted in the first direction in step (B).

12. A method for inspecting a defect of a circuit pattern of a semiconductor device, the method to be implemented by an inspecting apparatus and comprising the steps of:
(K) extracting, using the inspection apparatus, a pattern contour of the circuit pattern from an image containing the circuit pattern;
(L) adjusting, using the inspection apparatus, the pattern contour extracted in step (K) by contracting a dimension of the pattern contour in a first direction, so as to generate a contracted contour;
(M) restoring, using the inspection apparatus, a dimension of the contracted contour in proportion to and in a direction opposite to the first direction in which the dimension of the pattern contour is contracted in step (L), so as to generate a first restored contour;
(N) adjusting, using the inspection apparatus, the pattern contour extracted in step (K) by expanding the dimension of the pattern contour in the first direction, so as to generate an expanded contour;
(O) restoring, using the inspection apparatus, a dimension of the expanded contour in proportion to and in a direction opposite to the first direction in which the dimension of the pattern contour is expanded in step (N), so as to generate a second restored contour; and
(P) performing, using the inspection apparatus, an exclusive or (XOR) logical operation upon the first restored contour and the second restored contour, so as to generate based on a result of the XOR logical operation an inspection data that is associated with a position of a defect of the circuit pattern.

13. The method as claimed in claim 12,
wherein, in step (K), the pattern contour extracted from the image containing the circuit pattern is two-dimensional; and
wherein each of steps (L) and (N) includes the sub-steps of
dividing, using the inspection apparatus, the pattern contour extracted in step (K) into a plurality of sub-pattern contours along the first direction, and
adjusting, using the inspection apparatus, at least one of the sub-pattern contours so as to generate a respective one of the contracted contour and the expanded contour.

14. A method for inspecting a defect of a circuit pattern of a semiconductor device, the method to be implemented by an inspecting apparatus and comprising the steps of:
(Q) obtaining, using the inspection apparatus, an image containing the circuit pattern that has at least two sides spaced apart from each other along one direction;
(R) measuring, using the inspection apparatus and along the direction, a distance defined by the at least two sides of the circuit pattern contained in the image which is obtained in step (Q); and
(S) comparing, using the inspection apparatus, the distance measured in step (R) with a predetermined fabrication threshold, so as to generate an inspection data that is associated with a position of a defect of the circuit pattern.

15. The method as claimed in claim 14, wherein:
in step (Q), the circuit pattern contained in the image includes a plurality of circuit pattern segments, each of the circuit pattern segments including at least one first side facing an adjacent one of the circuit pattern segments along the direction, each of the circuit pattern segments further including a pair of second sides that define said circuit pattern segment along the direction;
in step (R), the inspection apparatus is configured to measure a first distance defined by adjacent two of the first sides that face each other, and a second distance defined by the pair of second sides of each of the circuit pattern segments; and
in step (S), each of the first distance and the second distance is compared with a respective one of a first predetermined fabrication threshold and a second predetermined fabrication threshold so as to generate a plurality entries of inspection data.

16. The method as claimed in claim 14, wherein steps (Q) to (S) are performed on a plurality of the circuit patterns so as to generate a plurality of the inspection data, the method further comprising:
analyzing, using the inspection apparatus, the plurality of the inspection data thus generated so as to generate defect category data, the defect category data including a random defect group which is associated with positions of the defects of the circuit patterns that have a random distribution, and a consistent defect group which is associated with positions of the defects of the circuit patterns that have a consistent distribution.

17. The method as claimed in claim 14,
wherein, in step (Q), the circuit pattern contained in the image is two-dimensional; and
wherein step (R) includes the sub-steps of
dividing, using the inspection apparatus, the circuit pattern contained in the image that is obtained in step (Q) into a plurality of sub-patterns along the direction, and
measuring, using the inspection apparatus along the direction, a distance defined by at least two sides of the sub-patterns.
